(19) United States
(12) Patent Application Publication
(10) Pub. No.: US 2022/0276344 A1
(43) Pub. Date: Sep. 1, 2022

(54) DISTANCE MEASURING DEVICE, ELECTRONIC EQUIPMENT, AND METHOD FOR MANUFACTURING DISTANCE MEASURING DEVICE

(71) Applicant: SONY SEMICONDUCTOR SOLUTIONS CORPORATION, Kanagawa (JP)

(72) Inventors: Hirohisa YASUKAWA, Kanagawa (JP); Masayuki NAGAO, Kanagawa (JP)

(73) Assignee: SONY SEMICONDUCTOR SOLUTIONS CORPORATION, Kanagawa (JP)

(21) Appl. No.: 17/631,970

(22) PCT Filed: Jul. 2, 2020
(86) PCT No.: PCT/JP2020/025939

§ 371 Date: Feb. 1, 2022

(30) Foreign Application Priority Data
Aug. 20, 2019 (JP) 2019-150228

(51) Int. Cl. G01S 7/481; G01S 17/89

(52) U.S. Cl. CPC G01S 7/4813; G01S 17/89

(57) ABSTRACT

A device includes a first substrate (903), a second substrate (100) on the first substrate (903), and a light emitting device (11) including a light source (300) on the second substrate (100) and that emits light toward an object. The light emitting device includes a driver (200) disposed in the second substrate (100) and that drives the light source (300). A portion of the driver (200) overlaps a first portion of the light source (300) in a plan view. The device includes an imaging device (12) on the first substrate adjacent to the light emitting device (11) and that senses light reflected from the object. The light-emitting device (11) reduces the wiring inductance by electrically connecting the light source (300) and the driver (200) via the connecting via (101). Further, the second substrate (100) includes a thermal via (102) for heat radiation. Considering that a certain number of thermal vias (102) are arranged immediately below the light source (300), the amount of overlap is desirably 50% or less. An upper surface surrounded by side wall (600) is covered by a diffuser plate (700). A light-receiving element (910) may be directly mounted as a bare chip on the substrate (903) by using an epoxy or silicone die attach material. The light source (300) preferably includes a semiconductor laser.

### CROSS REFERENCE TO RELATED APPLICATIONS

This application claims the benefit of Japanese Priority Patent Application JP 2019-150228 filed on Aug. 20, 2019, the entire contents of which are incorporated herein by reference.

### TECHNICAL FIELD

The present technology relates to a distance measuring device that measures a distance to an object. More specifically, the present technology relates to a distance measuring device, electronic equipment, and a method for manufacturing the distance measuring device that can be suitably used for mobile equipment.

### BACKGROUND ART

Conventionally, in an electronic device having a distance measuring function, a distance measuring method called time of flight (ToF) has often been used. This ToF is a method in which a light-emitting unit irradiates an object with sine-wave or rectangular-wave irradiation light, a light-receiving unit receives reflected light from the object, and a distance measuring operation part measures a distance from a phase difference between the irradiation light and the reflected light. There is known an optical module in which a light-emitting element and an electronic semiconductor chip for driving the light-emitting element are housed in a casing and integrated in order to realize the distance measuring function as described above. For example, there has been proposed an optical module including: a laser diode array arrayed and mounted on an electrode pattern of a substrate; and a driver integrated circuit (IC) electrically connected to the laser diode array (e.g., see Patent Literature 1).

### CITATION LIST

### Patent Literature

PTL 1: JP 2009-170675A

### SUMMARY

### Technical Problem

In the related art described above, the laser diode array and the driver IC are integrated and configured as an optical module. However, in this related art, the laser diode array and the driver IC are electrically connected by a plurality of wires, and wiring inductance therebetween increases, whereby there is a possibility that the driving waveform of the semiconductor laser may be distorted. This is particularly problematic for ToF driven at hundreds of megahertz.

The present technology has been developed in view of such a situation, and it is desirable to provide a small and highly sensitive distance measuring device by use of a light-emitting unit and a light-receiving unit having a structure for reducing wiring inductance between a semiconductor laser and a laser driver.

### Solution to Problem

According to an embodiment of the present technology, there are provided a distance measuring device and electronic equipment provided with the distance measuring device, the device including: a substrate with a laser driver built inside; a semiconductor laser that is mounted on one surface of the substrate and emits irradiation light; connection wiring that electrically connects the laser driver and the semiconductor laser with a wiring inductance of 0.5 nH or less; and a light-receiving unit that receives reflected light from an object to the irradiation light. This brings an effect of electrically connecting the laser driver and the semiconductor laser with a wiring inductance of 0.5 nH or less.

Moreover, in the embodiment, the distance measuring device may further include a distance measuring operation part that measures a distance to the object on the basis of the irradiation light and the reflected light.

Further, in the embodiment, the light-receiving unit may be formed on a rigid board in a rigid flexible printed wiring board in which the rigid board and a flexible wiring board are integrated, and the light-receiving unit may be connected to the substrate with the laser driver built inside via the flexible wiring board. This brings an effect of forming the light-emitting unit and the light-receiving unit as the distance measuring device by using the rigid flexible printed wiring board.

Further, in the embodiment, the substrate with the laser driver built inside and the light-receiving unit may be formed on the same common substrate. This brings an effect of integrally forming the light-emitting unit and the light-receiving unit on a common substrate as the distance measuring device. In this case, as the common substrate, for example, a motherboard or an interposer that performs relay to the motherboard is assumed.

Further, in the embodiment, the light-receiving unit may be formed on the substrate with the laser driver built inside. This brings an effect of integrally forming the light-receiving unit on the substrate of the light-emitting unit.

Moreover, in the embodiment, the distance measuring device further includes a transmission window that transmits the irradiation light and the reflected light, in which an angle of the irradiation light from a light-emitting unit and a light-receiving angle of view of the light-receiving unit desirably do not overlap each other up to a position of the transmission window. This brings an effect of preventing (or reducing) irradiation light emitted from the light-emitting unit from being reflected on the transmission window and being incident on the light-receiving unit.

Further, in the embodiment, the connection wiring desirably has a length of 0.5 mm or less. Further, the connection wiring is more preferably 0.3 mm or less.

Further, in the embodiment, the connection wiring may be through a connecting via provided on the substrate. This brings an effect of shortening the wiring length.

Further, in the embodiment, a part of the semiconductor laser may be disposed to overlap above the laser driver. In this case, a portion of 50% or less of an area of the semiconductor laser may be disposed to overlap the laser driver thereabove.

Further, a method for manufacturing a distance measuring device according to an embodiment of the present technology includes: forming a laser driver on an upper surface of a support plate; forming connection wiring of the laser driver and forming a substrate with the laser driver built inside; mounting a semiconductor laser that emits irradiation light on one surface of the substrate and forming connection wiring that electrically connects, via the connection wiring, the laser driver and the semiconductor laser with a wiring inductance of 0.5 nH or less; and forming a light-receiving unit that receives reflected light from an object to the irradiation light. This brings an effect of manufacturing a distance measuring device that electrically connects the laser driver and the semiconductor laser with a wiring inductance of 0.5 nH or less.

According to an embodiment of the present technology, a device includes a first substrate, a second substrate on the first substrate, and a light emitting device including a light source on the second substrate and that emits light toward an object. The light emitting device includes a driver disposed in the second substrate and that drives the light source. A portion of the driver overlaps a first portion of the light source in a plan view. The device includes an imaging device on the first substrate adjacent to the light emitting device and that senses light reflected from the object. The light emitting device further comprises at least one first via disposed in the second substrate and overlapping with a second portion of the light source in the plan view. The at least one first via extends through the second substrate. The light emitting device further comprises at least one second via disposed in the second substrate that electrically connects the light source to the driver. The light emitting device further comprises at least one passive component on the second substrate. The device further comprises a support structure that surrounds the at least one passive component and the light source. The device further comprises an optical element supported by the support structure. The optical element diffuses light emitted from the light source. The support structure is mounted to the second substrate. The driver overlaps a portion of the at least one passive component in the plan view. The at least one passive component includes a decoupling capacitor. The first portion of the light source is less than 50% of a surface area of a surface of the light source. The light source includes a laser. A footprint of the imaging device is greater than a footprint of the light emitting device. According to an embodiment of the present technology, a device includes a light emitting device including a light source on a first substrate and that emits light toward an object, and a driver disposed in the first substrate and that drives the light source. A portion of the driver overlaps less than 50% of the light source in a plan view. The device includes an imaging device that senses light reflected from the object. The device further comprises a second substrate, and the imaging device and the first substrate are mounted on the second substrate. The light emitting device further comprises at least one first via disposed in the second substrate and overlapping the light source in the plan view. The at least one first via extends through the first substrate. The light emitting device further comprises at least one second via disposed in the second substrate that electrically connects the light source to the driver. According to an embodiment of the present technology, a device includes a first substrate, and a light emitting device including a light source on the first substrate and that emits light toward an object, and a driver disposed in the second substrate and that drives the light source. A portion of the driver overlaps a first portion of the light source in a plan view. The device includes a second substrate and an imaging device on the second substrate and that senses light reflected from the object. The device further includes a connector that electrically connects the light emitting device to the imaging device.

### BRIEF DESCRIPTION OF DRAWINGS

FIG. 1 is a diagram illustrating a configuration example of a distance measuring module according to an embodiment of the present technology.

FIG. 2 is a view illustrating an example of a top view of a light-emitting unit according to the embodiment of the present technology.

FIG. 3 is a view illustrating an example of a cross-sectional view of the light-emitting unit according to the embodiment of the present technology.

FIG. 4A is a view illustrating a definition of the amount of overlap between a laser driver and a semiconductor laser according to the embodiment of the present technology.

FIG. 4B is a view illustrating a definition of the amount of overlap between a laser driver and a semiconductor laser according to the embodiment of the present technology.

FIG. 4C is a view illustrating a definition of the amount of overlap between a laser driver and a semiconductor laser according to the embodiment of the present technology.

FIG. 5 is a diagram illustrating a numerical example of a wiring inductance with respect to a wiring length and a wiring width in a case where a wiring pattern is formed by an additive method.

FIG. 6 is a diagram illustrating a numerical example of the wiring inductance with respect to the wiring length and the wiring width in a case where a wiring pattern is formed by a subtractive method.

FIG. 7A is a first view illustrating an example of a step of processing a copper land and a copper wiring layer (redistribution layer: RDL) in the manufacturing process of the laser driver according to the embodiment of the present technology.

FIG. 7B is the first view illustrating an example of a step of processing a copper land and a copper wiring layer (redistribution layer: RDL) in the manufacturing process of the laser driver according to the embodiment of the present technology.

FIG. 7C is the first view illustrating an example of a step of processing a copper land and a copper wiring layer (redistribution layer: RDL) in the manufacturing process of the laser driver according to the embodiment of the present technology.

FIG. 8A is a second view illustrating an example of a step of processing a copper land and a copper wiring layer (redistribution layer: RDL) in the manufacturing process of the laser driver according to the embodiment of the present technology.

FIG. 8B is the second view illustrating an example of a step of processing a copper land and a copper wiring layer (redistribution layer: RDL) in the manufacturing process of the laser driver according to the embodiment of the present technology.

FIG. 8C is the second view illustrating an example of a step of processing a copper land and a copper wiring layer (redistribution layer: RDL) in the manufacturing process of the laser driver according to the embodiment of the present technology.

FIG. 9A is a first view illustrating an example of the manufacturing process of the substrate according to the embodiment of the present technology.

FIG. 9B is the first view illustrating an example of the manufacturing process of the substrate according to the embodiment of the present technology.

FIG. 9C is the first view illustrating an example of the manufacturing process of the substrate according to the embodiment of the present technology.

FIG. 9D is the first view illustrating an example of the manufacturing process of the substrate according to the embodiment of the present technology.

FIG. 10A is a second view illustrating an example of the manufacturing process of the substrate according to the embodiment of the present technology.

FIG. 10B is the second view illustrating an example of the manufacturing process of the substrate according to the embodiment of the present technology.

FIG. 10C is the second view illustrating an example of the manufacturing process of the substrate according to the embodiment of the present technology.

FIG. 10D is the second view illustrating an example of the manufacturing process of the substrate according to the embodiment of the present technology.

FIG. 11A is a third view illustrating an example of the manufacturing process of the substrate according to the embodiment of the present technology.

FIG. 11B is the third view illustrating an example of the manufacturing process of the substrate according to the embodiment of the present technology.

FIG. 11C is the third view illustrating an example of the manufacturing process of the substrate according to the embodiment of the present technology.

FIG. 12A is a fourth view illustrating an example of the manufacturing process of the substrate according to the embodiment of the present technology.

FIG. 12B is the fourth view illustrating an example of the manufacturing process of the substrate according to the embodiment of the present technology.

FIG. 12C is the fourth view illustrating an example of the manufacturing process of the substrate according to the embodiment of the present technology.

FIG. 13A is a fifth view illustrating an example of the manufacturing process of the substrate according to the embodiment of the present technology.

FIG. 13B is the fifth view illustrating an example of the manufacturing process of the substrate according to the embodiment of the present technology.

FIG. 13C is the fifth view illustrating an example of the manufacturing process of the substrate according to the embodiment of the present technology.

FIG. 14 is a cross-sectional view illustrating a first example of the mounting structure of the distance measuring module according to the embodiment of the present technology.

FIG. 15 is a cross-sectional view illustrating a second example of the mounting structure of the distance measuring module according to the embodiment of the present technology.

FIG. 16 is a cross-sectional view illustrating a third example of the mounting structure of the distance measuring module according to the embodiment of the present technology.

FIG. 17 is a cross-sectional view illustrating an example of an assumed size of the distance measuring module according to the embodiment of the present technology.

FIG. 18A is a view illustrating an example of a top view of a distance measuring module according to the embodiment of the present technology.

FIG. 18B is a cross-sectional view illustrating an example of a mounting structure of the distance measuring module in FIG. 18A according to the embodiment of the present technology.

FIG. 19 is a diagram illustrating a system configuration example of electronic equipment which is an application example of the embodiment of the present technology.

FIG. 20 is a view illustrating an external configuration example of the electronic equipment which is an application example of the embodiment of the present technology.

### DESCRIPTION OF EMBODIMENTS

Hereinafter, a mode for implementing the present technology (hereinafter referred to as embodiment) will be described. The description will be made in the following order.

1. Embodiment (distance measuring module)

2. Application Example (electronic equipment)

### 1. Embodiment

“Configuration of Distance Measuring Module”

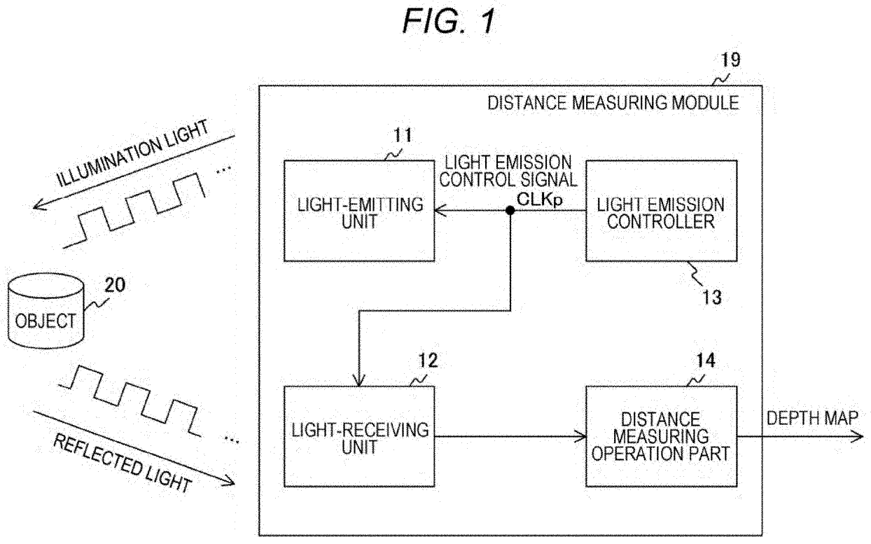

FIG. 1 is a diagram illustrating a configuration example of a distance measuring module 19 according to an embodiment of the present technology.

The distance measuring module 19 measures a distance by the ToF method, and includes a light-emitting unit 11 (or light emitting device), a light-receiving unit (or light detecting device or imaging device) 12, a light emission controller 13, and a distance measuring operation part 14.

The light-emitting unit 11 emits irradiation light with its brightness varying periodically and irradiates an object 20 with the light. The light-emitting unit 11 generates irradiation light in synchronization with, for example, a rectangular-wave light emission control signal CLKp. Further, for example, a laser or a light-emitting diode is used as the light-emitting unit 11, and infrared light or near-infrared light having a wavelength in the range of 780 nm to 1000 nm is used as the irradiation light. Note that the light emission control signal CLKp is not limited to a rectangular wave so long as being a periodic signal. For example, the light emission control signal CLKp may be a sine wave.

The light emission controller 13 controls the irradiation timing of the irradiation light. The light emission controller 13 generates the light emission control signal CLKp and supplies the generated signal to the light-emitting unit 11 and the light-receiving unit 12. Further, the light emission control signal CLKp may be generated by the light-receiving unit 12, and in that case, the light emission control signal CLKp generated by the light-receiving unit 12 is amplified by the light emission controller 13 and supplied to the light-emitting unit 11. The frequency of the light emission control signal CLKp is, for example, 100 megahertz (MHz). Note that the frequency of the light emission control signal CLKp is not limited to 100 MHz but may be 200 MHz or the like. Further, the light emission control signal CLKp may be a single-ended signal or a differential signal.

The light-receiving unit 12 receives the light reflected from the object 20 and detects the amount of light received within a period of a vertical synchronization signal every time the period elapses. For example, a 60-Hz periodic signal is used as the vertical synchronization signal. Further, in the light-receiving unit 12, a plurality of pixel circuits is arranged in a two-dimensional lattice. The light-receiving unit 12 supplies image data (frames) made up of pieces of pixel data corresponding to the amounts of light received by these pixel circuits to the distance measuring operation part 14. Note that the frequency of the vertical synchronization signal is not limited to 60 Hz but may, for example, be 30 Hz or 120 Hz.

The distance measuring operation part 14 measures the distance to the object 20 on the basis of image data by the ToF method. The distance measuring operation part 14 measures the distance for each pixel circuit, and generates a depth map indicating the distance to the object 20 by a gradation value for each pixel. This depth map is used for, for example, image processing for performing blurring processing with a degree in accordance with the distance, and autofocus (AF) processing for obtaining a focal point of a focus lens in accordance with the distance. Further, the depth map is expected to be used for gesture recognition, object recognition, obstacle detection, augmented reality (AR), virtual reality (VR), and the like.

“Configuration of Light-Emitting Unit”

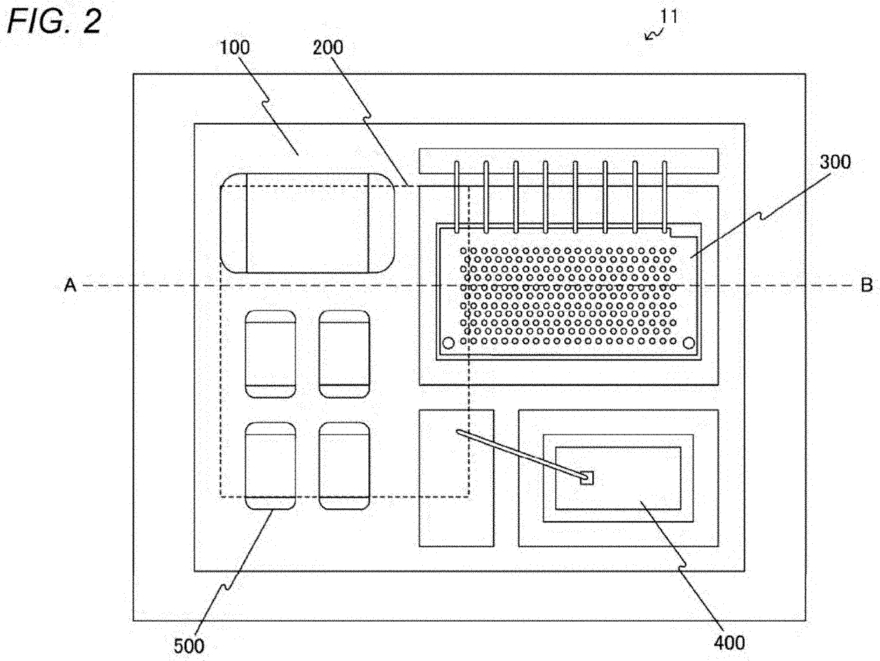

FIG. 2 is a view illustrating an example of a top view of the light-emitting unit 11 according to the embodiment of the present technology.

This light-emitting unit 11 is assumed to measure the distance by ToF. The ToF has features of having high depth accuracy, although not as high as that of structured light, and being operable without problems even in a dark environment. In addition, the ToF is considered to have many merits as compared to other methods such as the structured light and a stereo camera in terms of simplicity of the device configuration and cost.

In the light-emitting unit 11, a semiconductor laser (or light source) 300, a photodiode 400, and a passive component 500 are electrically connected and mounted by wire bonding on the surface of the substrate 100 with a laser driver 200 built inside. As the substrate 100, a printed wiring board is assumed.

The semiconductor laser 300 is a semiconductor device that emits laser light by allowing a current to flow through a p-n junction of a compound semiconductor. Here, as the compound semiconductor to be used, for example, aluminum gallium arsenide (AlGaAs), indium gallium arsenide phosphorus (InGaAsP), aluminum gallium indium phosphorus (AlGaInP), gallium nitride (GaN), and the like are assumed.

The laser driver 200 is a driver integrated circuit (IC) for driving the semiconductor laser 300. The laser driver 200 is built in the substrate 100 in a face-up state. As for the electrical connection with the semiconductor laser 300, due to the need for reducing wiring inductance, it is desirable to make the wiring length as short as possible. The specific numerical values thereof will be described later.

The photodiode 400 is a diode for detecting light. The photodiode 400 is used for automatic power control (APC) for monitoring the light intensity of the semiconductor laser 300 and keeping the output of the semiconductor laser 300 constant.

The passive component 500 is a circuit component except for active elements such as a capacitor and a resistor. The passive component 500 includes a decoupling capacitor for driving the semiconductor laser 300.

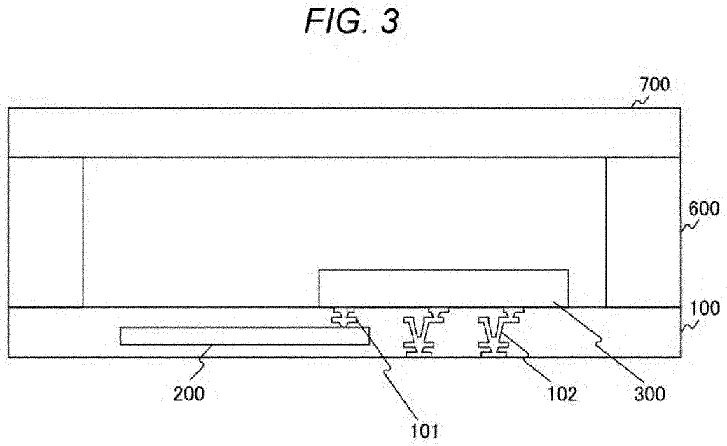

FIG. 3 is a view illustrating an example of a cross-sectional view of the light-emitting unit 11 according to the embodiment of the present technology.

As described above, the substrate 100 has the laser driver 200 built inside and has the semiconductor laser 300 and the like mounted on the surface. The connection between the semiconductor laser 300 and the laser driver 200 is made via a connecting via 101. By using the connecting via 101, the wiring length can be shortened. Note that connecting via 101 is an example of the connection wiring recited in the claims.

Further, the substrate 100 includes a thermal via 102 for heat radiation. Each component mounted on the substrate 100 is a heat source, and by using the thermal via 102, the heat generated in each component can be radiated from the back surface of the substrate 100.

The semiconductor laser 300, the photodiode 400, and the passive component 500 mounted on the surface of the substrate 100 are surrounded by a side wall (or support structure) 600. As a material of the side wall 600, for example, a plastic material or a metal is assumed.

The upper surface surrounded by the side wall 600 is covered by a diffuser plate 700. The diffuser plate 700 is an optical element for diffusing laser light from the semiconductor laser 300 and is also called a diffuser.

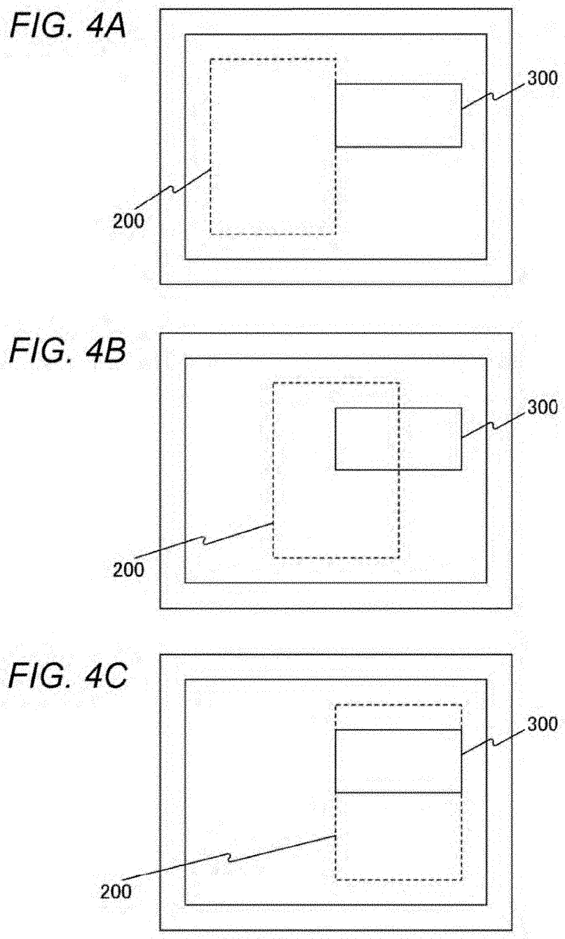

FIGS. 4A to 4C are views each illustrating a definition of the amount of overlap between the laser driver 200 and the semiconductor laser 300 according to the embodiment of the present technology.

As described above, since the connection between the semiconductor laser 300 and the laser driver 200 is assumed to be made via the connecting via 101, the semiconductor laser 300 and the laser driver 200 are disposed to overlap as viewed from the top. On the other hand, the thermal via 102 is desirably provided on the lower surface of the semiconductor laser 300, and a region for that needs to be ensured. Therefore, in order to clarify the positional relationship between the laser driver 200 and the semiconductor laser 300, the amount of overlap therebetween is defined as follows.

In the placement illustrated in FIG. 4A, there is no overlapping region in the laser driver 200 or the semiconductor laser 300 as viewed from above. The amount of overlap in this case is defined as 0%. On the other hand, in the placement illustrated in FIG. 4C, the entire semiconductor laser 300 overlaps the laser driver 200 as viewed from above. The amount of overlap in this case is defined as 100%.

Then, in the placement illustrated in FIG. 4B, a half region of the semiconductor laser 300 as viewed from above overlaps the laser driver 200. The amount of overlap in this case is defined as 50%.

In the present embodiment, in order to provide a region for the connecting via 101 described above, the amount of overlap is desirably larger than 0%. On the other hand, considering that a certain number of thermal vias 102 are arranged immediately below the semiconductor laser 300, the amount of overlap is desirably 50% or less. Therefore, by setting the amount of overlap to be more than 0% and 50% or less, it is possible to reduce wiring inductance and obtain favorable heat radiation characteristics.

“Wiring Inductance”

As described above, in the connection between the semiconductor laser 300 and the laser driver 200, the wiring inductance is problematic. All conductors have inductive components, and in a high-frequency region such as the ToF system, the inductance of even a very short lead can have an adverse effect. That is, at the time of high-frequency operation, a drive waveform for driving the semiconductor laser 300 from the laser driver 200 may be distorted due to the influence of the wiring inductance, and the operation may be unstable.

Here, a theoretical formula for calculating the wiring inductance will be considered. For example, an inductance IDC [μH] of a linear lead having a circular section with a length L [mm] and a radius R [mm] is expressed by the following equation in free space. Here, ln represents a natural logarithm.

IDC=0.0002L·(ln(2L/R)−0.75)

Further, for example, the inductance IDC [μH] of a strip line (substrate wiring pattern) having a length L [mm], a width W [mm], and a thickness H [mm] is expressed by the following equation in free space.

IDC=0.0002L·(ln(2L/(W+H))+0.2235((W+H)/L)+0.5)

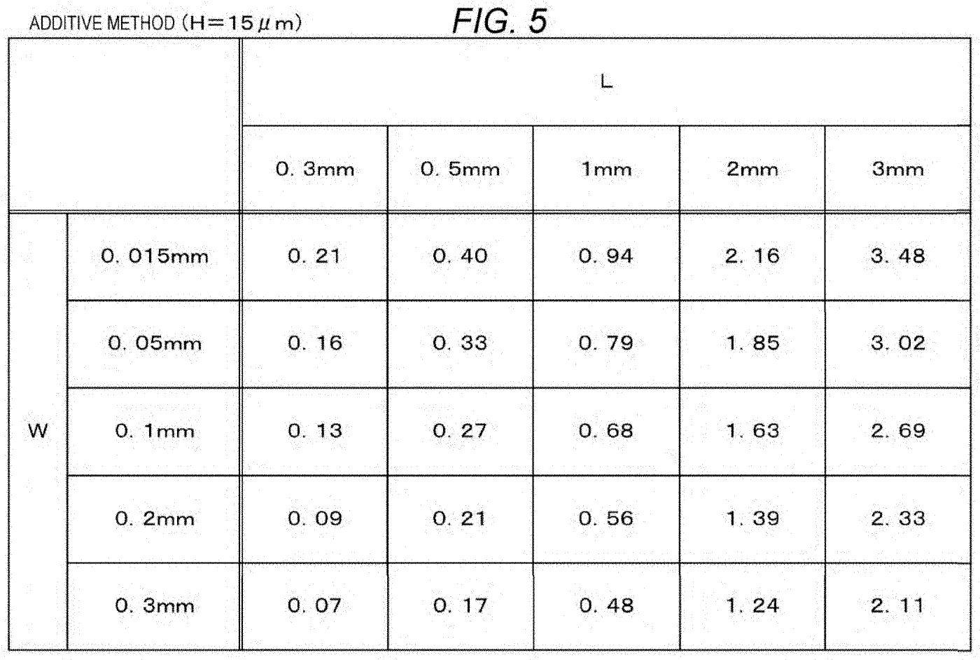

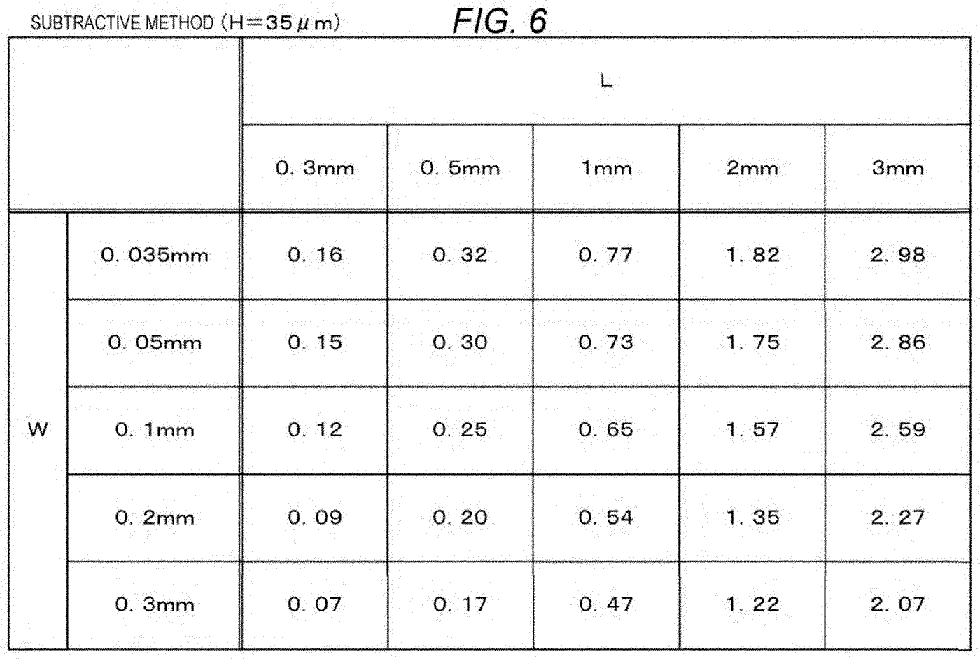

FIGS. 5 and 6 illustrate a trial calculation of the wiring inductance [nH] between the laser driver built inside the printed wiring board and the semiconductor laser electrically connected to the upper part of the printed wiring board.

FIG. 5 is a diagram illustrating a numerical example of a wiring inductance with respect to a wiring length L and a wiring width W in a case where a wiring pattern is formed by an additive method. The additive method is a method of forming a pattern by depositing copper only on a necessary portion of an insulating resin surface.

FIG. 6 is a diagram illustrating a numerical example of the wiring inductance with respect to the wiring length L and the wiring width W in a case where a wiring pattern is formed by a subtractive method. The subtractive method is a method of forming a pattern by etching an unnecessary portion of the copper clad laminate.

In the case of the distance measuring module such as the ToF system, assuming that the module is driven at several hundred megahertz, the wiring inductance is desirably 0.5 nH or less, and more preferably 0.3 nH or less. Therefore, in consideration of the calculation results described above, it is considered that the wiring length between the semiconductor laser 300 and the laser driver 200 is desirably 0.5 mm or less, and more preferably 0.3 mm or less.

“Manufacturing Method”

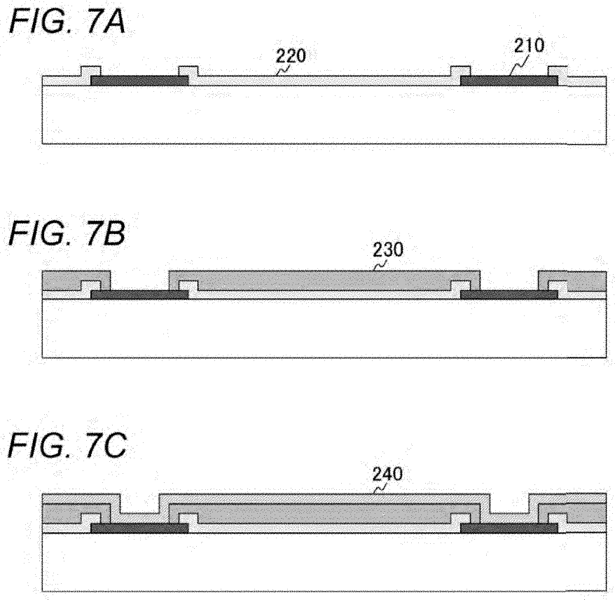

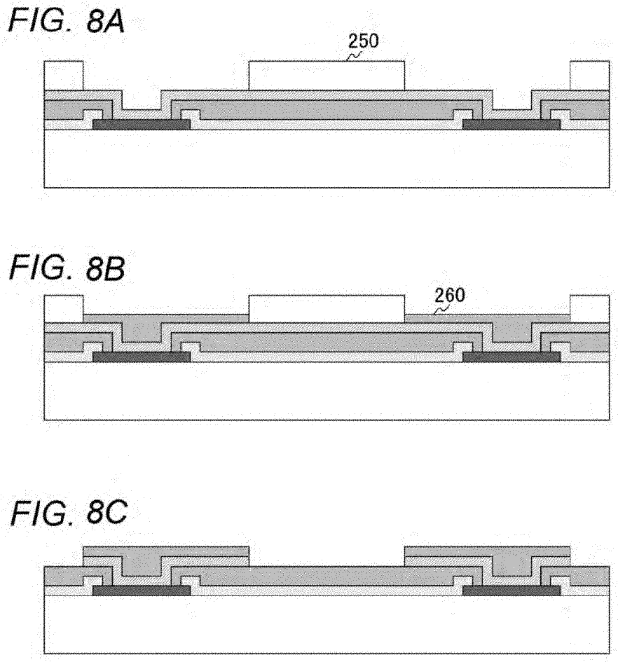

FIGS. 7A to 7C and FIGS. 8D to 8F are views each illustrating an example of a step of processing a copper land and a copper wiring layer (redistribution layer: RDL) in the manufacturing process of the laser driver 200 according to the embodiment of the present technology.

First, as illustrated in FIG. 7A, an input/output (I/O) pad 210 including, for example, aluminum or the like is formed on a semiconductor wafer. Then, a protective insulation layer 220 such as SiN is formed on the surface, and a region of the I/O pad 210 is opened.

Next, as illustrated in FIG. 7B, a surface protection film 230 including polyimide (PI) or polybenzoxazole (PBO) is formed, and a region of the I/O pad 210 is opened.

Next, as illustrated in in FIG. 7C, titanium tungsten (TiW) of about several tens to hundreds of nm and copper (Cu) of about one hundred to thousand nm are continuously sputtered to form an adhesion layer-seed layer 240. Here, a high melting point metal such as chromium (Cr), nickel (Ni), titanium (Ti), titanium copper (TiCu), or platinum (Pt), or an alloy thereof may be applied to the adhesion layer in addition to titanium tungsten (TiW). Further, nickel (Ni), silver (Ag), gold (Au), or an alloy thereof may be applied to the seed layer in addition to copper (Cu).

Next, as illustrated in FIG. 8A, a photoresist 250 is patterned in order to form a copper land and a copper wiring layer for electrical bonding. Specifically, the formation is performed by each of the steps of surface cleaning, resist coating, drying, exposure, and development.

Next, as illustrated in FIG. 8B, a copper land-copper wiring layer (RDL) 260 for electrical bonding is formed on the adhesion layer-seed layer 240 by a plating method. Here, as the plating method, for example, an electrolytic copper plating method, an electrolytic nickel plating method, or the like can be used. Further, it is desirable that the diameter of the copper land be about 50 to 100 μm, the thickness of the copper wiring layer be about 3 to 10 μm, and the minimum width of the copper wiring layer be about 10 μm.

Next, as illustrated in FIG. 8C, the photoresist 250 is removed, and copper land-copper wiring layer (RDL) 260 of a semiconductor chip is masked, and dry etching is performed. Here, as the dry etching, for example, ion milling for performing irradiation with an argon ion beam can be used. By the dry etching, the adhesion layer-seed layer 240 in the unnecessary region can be selectively removed, and the copper land and the copper wiring layer are separated from each other. Note that although the removal of the unnecessary region can be performed by wet etching with aqua regia, an aqueous solution of ceric ammonium nitrate or potassium hydroxide, or the like, dry etching is more desirable considering the side etching and thickness reduction of the metal layer constituting the copper land and the copper wiring layer.

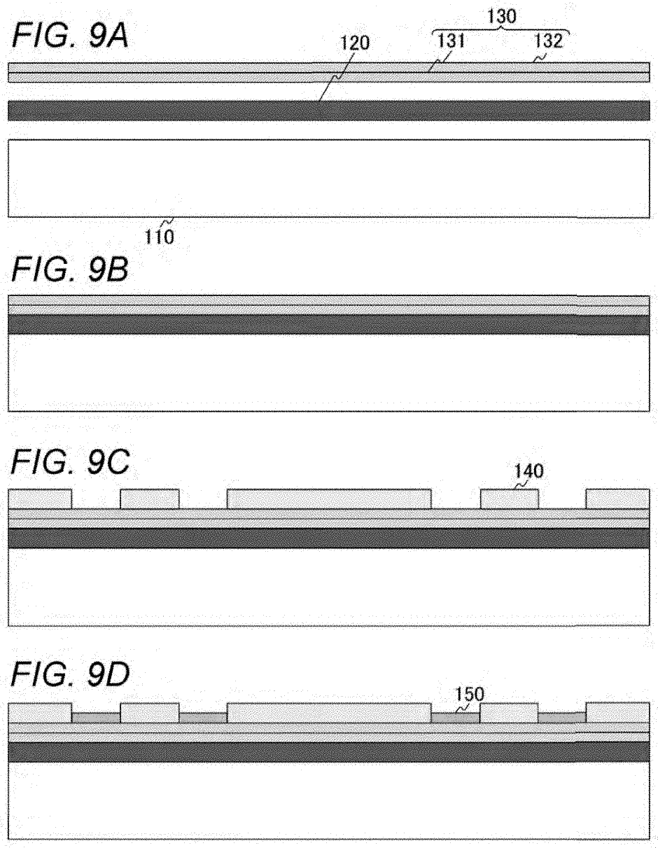

FIG. 9A to FIG. 13C are views each illustrating an example of the manufacturing process of the substrate 100 according to the embodiment of the present technology.

First, as illustrated in FIG. 9A, a peelable copper foil 130 having a two-layer structure of an ultra-thin copper foil 132 and a carrier copper foil 131 is thermocompression-bonded on one side of the support plate 110 by roll lamination or lamination press via an adhesive resin layer 120.

As the support plate 110, a substrate including an inorganic material, a metal material, a resin material, or the like can be used. For example, silicon (Si), glass, ceramic, copper, copper-based alloy, aluminum, aluminum alloy, stainless steel, polyimide resin, and epoxy resin can be used.

As the peelable copper foil 130, one formed by vacuum adhesion of the carrier copper foil 131 having a thickness of 18 to 35 μm to the ultra-thin copper foil 132 having a thickness of 2 to 5 μm is used. As the peelable copper foil 130, for example, 3FD-P3/35 (manufactured by Furukawa Circuit Foil Co., Ltd.), MT-18S5DH (manufactured by Mitsui Mining & Smelting Co., Ltd.), or the like can be used.

As a resin material of the adhesive resin layer 120, it is possible to use an organic resin containing a glass fiber reinforcing material, such as epoxy resin, polyimide resin, polyphenyleneether (PPE) resin, phenol resin, polytetrafluoroethylene (PTFE) resin, silicon resin, polybutadiene resin, polyester resin, melamine resin, urea resin, polyphenylenesulfide (PPS) resin, or polyphenylene oxide (PPO) resin. Further, as the reinforcing material, an aramid nonwoven fabric, an aramid fiber, a polyester fiber, or the like can also be used in addition to the glass fiber.

Next, as illustrated in FIG. 9B, a plating underlying conductive layer (not illustrated) having a thickness of 0.5 to 3 μm is formed on the surface of the ultra-thin copper foil 132 of the peelable copper foil 130 by electroless copper plating processing. Note that this electroless copper plating processing forms a conductive layer as a base of electrolytic copper plating for forming a wiring pattern in the next step. However, this electroless copper plating processing may be omitted, and the wiring pattern may be formed by bringing an electrode for electrolytic copper plating into direct contact with the peelable copper foil 130 to perform electrolytic copper plating processing directly on the peelable copper foil 130.

Next, as illustrated in FIG. 9C, a photosensitive resist is attached to the surface of the support plate by roll lamination to form a resist pattern (solder resist 140) for the wiring pattern. As the photosensitive resist, for example, a plating resist of a dry film can be used.

Next, as illustrated in FIG. 9D, a wiring pattern 150 having a thickness of about 15 μm is formed by the electrolytic copper plating processing.

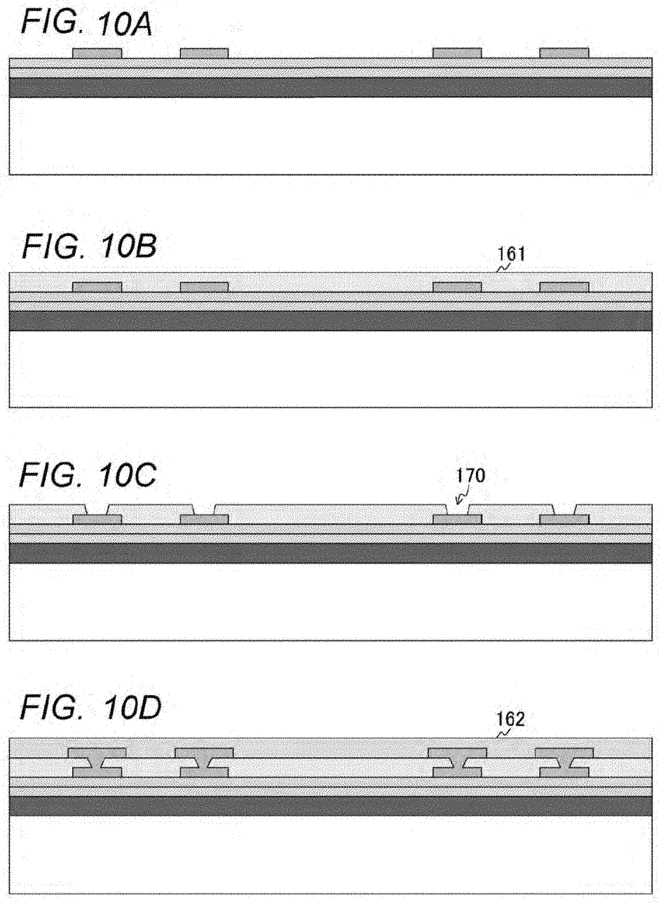

Next, as illustrated in FIG. 10A, the plating resist is peeled off. Then, as a pretreatment for forming an interlayer insulating resin, the surface of the wiring pattern is subjected to roughening treatment to improve the adhesion between the interlayer insulating resin and the wiring pattern. Note that the roughening treatment can be performed by blackening treatment using an oxidation-reduction treatment or soft etching treatment of a persulfuric acid system.

Next, as illustrated in FIG. 10B, an interlayer insulating resin 161 is thermocompression-bonded on the wiring pattern by roll lamination or lamination press. For example, an epoxy resin having a thickness of 45 μm is roll-laminated. In the case of using a glass epoxy resin, copper foils with a freely selected thickness are stacked and thermocompression-bonded by lamination press. As a resin material of the interlayer insulating resin 161, it is possible to use an organic resin such as epoxy resin, polyimide resin, PPE resin, phenol resin, PTFE resin, silicon resin, polybutadiene resin, polyester resin, melamine resin, urea resin, PPS resin, or PPO resin. In addition, these resins may be used alone or a combination of resins, obtained by mixing a plurality of resins or forming a compound, may be used. Moreover, an interlayer insulating resin in which an inorganic filler is contained in these materials or a glass fiber reinforcing material is mixed can also be used.

Next, as illustrated in FIG. 10C, a via hole for interlayer electrical connection is formed by a laser method or a photoetching method. In a case where the interlayer insulating resin 161 is a thermosetting resin, the via hole is formed by the laser method. As the laser light, an ultraviolet laser, such as a harmonic yttrium aluminum garnet (YAG) laser or an excimer laser, or an infrared laser, such as a carbon dioxide gas laser, can be used. Note that in a case where a via hole is formed by laser light, a thin resin film may remain on the bottom of the via hole, and hence desmearing treatment is performed. In this desmearing treatment, a resin is swollen by a strong alkali, and the resin is decomposed and removed using an oxidizing agent such as chromic acid or a permanganate aqueous solution. Further, the resin can also be removed by plasma treatment or sandblasting treatment with an abrasive. In a case where the interlayer insulating resin 161 is a photosensitive resin, a via hole 170 is formed by the photoetching method. That is, the via hole 170 is formed by performing exposure using ultraviolet light through a mask and then developing.

Next, after the roughening treatment, the electroless plating processing is performed on the wall surface of the via hole 170 and the surface of the interlayer insulating resin 161. Next, a photosensitive resist is attached by roll lamination to the surface of the interlayer insulating resin 161 with its surface subjected to the electroless plating processing. As the photosensitive resist in this case, for example, a photosensitive plating resist film of a dry film can be used. The photosensitive plating resist film is exposed and then developed to form a plating resist pattern in which a portion for the via hole 170 and a portion for the wiring pattern are opened. Next, the opening portion of the plating resist pattern is subjected to the electrolytic copper plating processing with a thickness of 15 μm. Then, by peeling off the plating resist and removing the electroless plating remaining on the interlayer insulating resin by flash etching of a persulfuric acid system or the like, a via hole 170 filled with copper plating and a wiring pattern as illustrated in in FIG. 10D are formed. Then, the similar roughening step for the wiring pattern and the similar formation step for an interlayer insulating resin 162 are performed repeatedly.

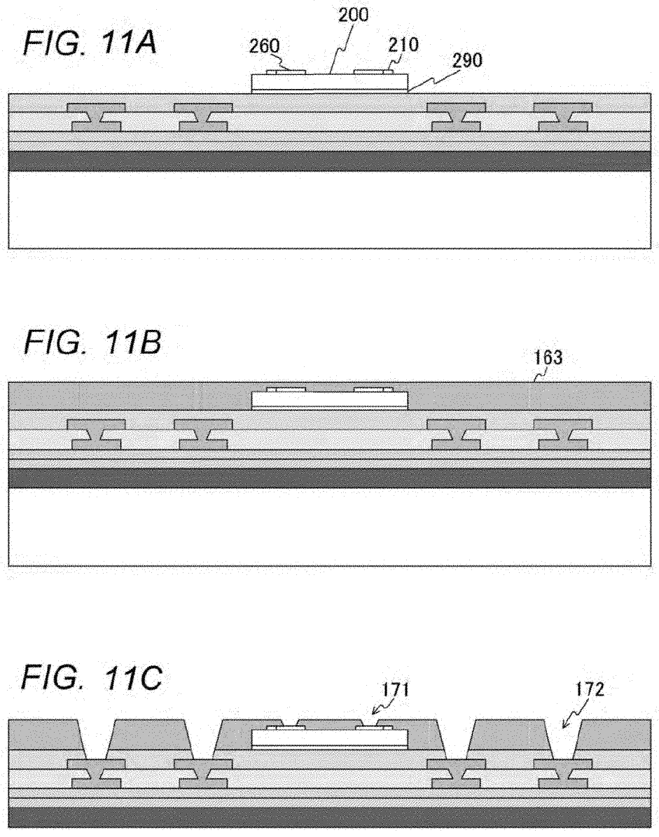

Next, as illustrated in FIG. 11A, the laser driver 200 with a die attach film (DAF) 290 having a processed copper land and copper wiring layer thinned to a thickness of about 30 to 50 μm is mounted in a face-up state.

Next, as illustrated in FIG. 11B, an interlayer insulating resin 163 is thermocompression-bonded by roll lamination or lamination press.

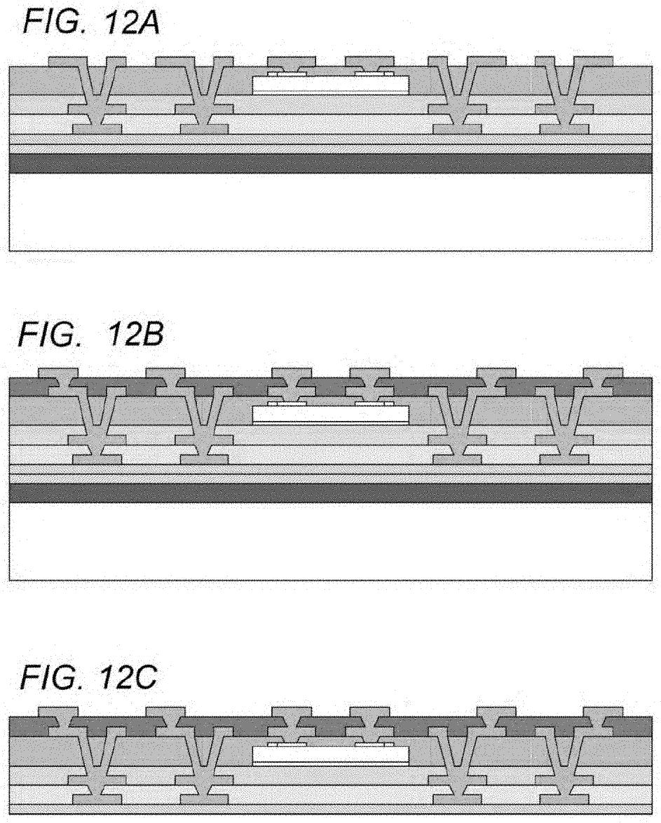

Next, as illustrated in FIG. 11C and FIG. 12A, the via hole processing, the desmearing treatment, the roughening treatment, the electroless plating processing, and the electrolytic plating processing which are similar to those performed until then are performed. Note that the processing of a shallow via hole 171 in the copper land of the laser driver 200, the processing of a deep via hole 172 one level lower, the desmearing treatment, and the roughening treatment are performed simultaneously.

Here, the shallow via hole 171 is a filled via filled with copper plating. The size and depth of the via are each about 20 to 30 μm. Further, the size of the land is about 60 to 80 μm in diameter.

On the other hand, the deep via hole 172 is a so-called conformal via in which copper is plated only on the outside of the via. The size and depth of the via are each about 80 to 150 μm. The size of the land is about 150 to 200 μm in diameter. Note that the deep via hole 172 is desirably disposed via an insulating resin of about 100 μm from the outer shape of the laser driver 200.

Next, as illustrated in FIG. 12B, an interlayer insulating resin similar to that used until then is thermocompression-bonded by roll lamination or lamination press. At this time, the inside of the conformal via is filled with an interlayer insulating resin. Next, the via hole processing, the desmearing treatment, the roughening treatment, the electroless plating processing, and the electrolytic plating processing which are similar to those performed until then are performed.

Next, as illustrated in FIG. 12C, the support plate 110 is separated by peeling off the interface between the carrier copper foil 131 and the ultra-thin copper foil 132 of the peelable copper foil 130.

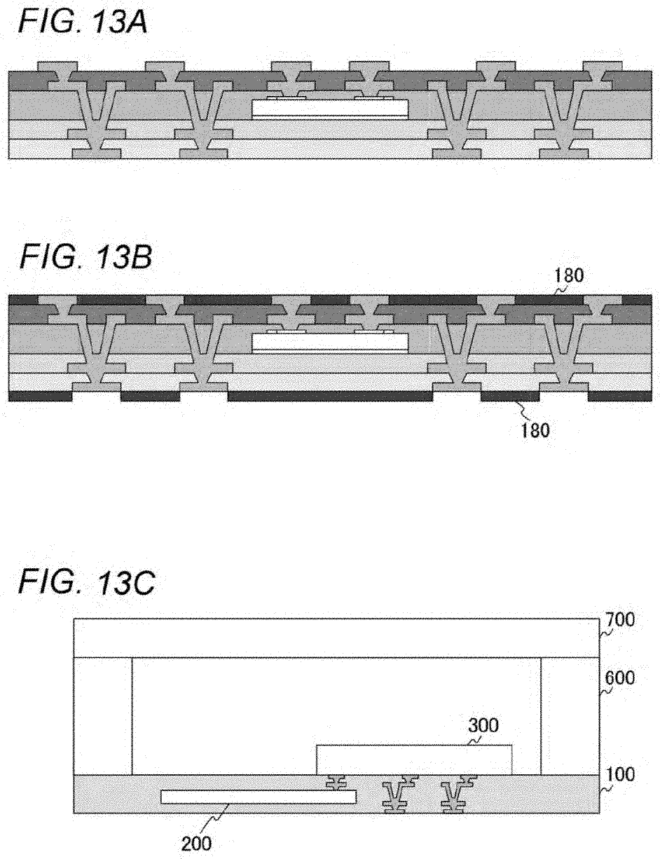

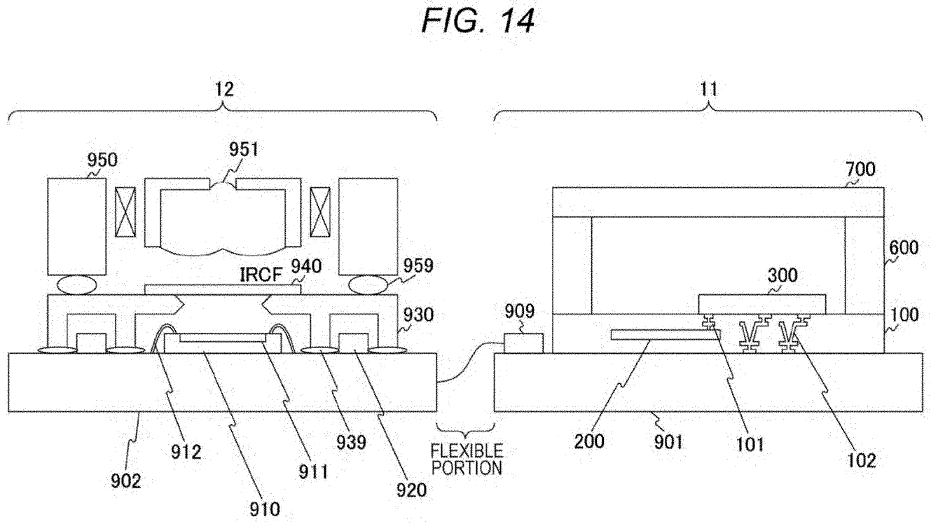

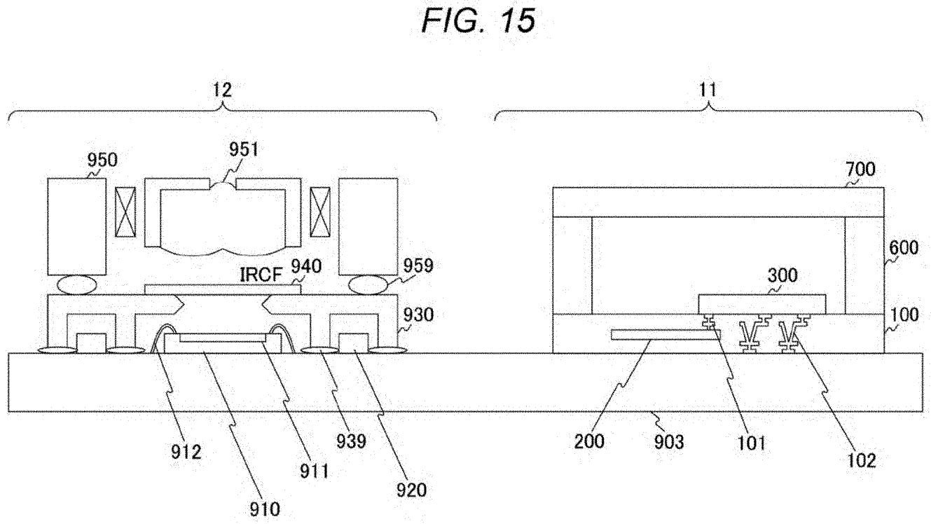

Next, as illustrated in FIG. 13A, the ultra-thin copper foil 132 and the plating underlying conductive layer are removed using sulfuric acid-hydrogen peroxide-based soft etching, so that it is possible to obtain a substrate with a built-in component where wiring pattern is exposed

Next, as illustrated in FIG. 13B, a solder resist 180 of a pattern having an opening in a land portion of the wiring pattern is printed on the exposed wiring pattern. Note that the solder resist 180 can also be formed by a roll coater using a film type. Next, electroless Ni plating is formed on the land portion of the opening in the solder resist 180 at 3 μm or more, and electroless Au plating is formed thereon at 0.03 μm or more. The electroless Au plating may be formed at 1 μm or more. Further, it is also possible to pre-coat a solder thereon. Alternatively, electrolytic Ni plating may be formed in the opening of the solder resist 180 at 3 μm or more, and electrolytic Au plating may be formed thereon at 0.5 μm or more. Moreover, in addition to the metal plating, an organic rust preventive (or reduction) film may be formed in the opening of the solder resist 180.

Also, a cream solder may be printed and applied as a connection terminal on a land for external connection, and a ball grid array (BGA) of a solder ball may be mounted. Further, as the connection terminal, a copper core ball, a copper pillar bump, a land grid array (LGA), or the like may be used.

As illustrated in FIG. 13C, the semiconductor laser 300, the photodiode 400, and the passive component 500 are mounted on the surface of the substrate 100 as thus manufactured, and a side wall 600 and the diffuser plate 700 are attached. In general, after the process is performed in the form of a collective substrate, the outer shape is processed with a dicing saw or the like to be separated into individual pieces.

Note that the example has been described in the steps described above where the peelable copper foil 130 and the support plate 110 are used, but instead of these, a copper clad laminate (CCL) can also be used. Further, as the manufacturing method to have the component built in the substrate, a method of forming a cavity in the substrate and mounting the component may be used.

“Mounting Structure of Distance Measuring Module”

FIG. 14 is a cross-sectional view illustrating a first example of the mounting structure of the distance measuring module 19 according to the embodiment of the present technology.

The distance measuring module 19 in the first example has a mounting structure in which the light-emitting unit 11 and the light-receiving unit 12 are manufactured separately and then connected via a connector 909.

As described above, the light-emitting unit 11 reduces the wiring inductance by electrically connecting the semiconductor laser 300 and the laser driver 200 via the connecting via 101. In the first example, the light-emitting unit 11 is formed on a substrate 901. The substrate 901 is provided with a connector 909, and the light-emitting unit 11 is electrically connected to the light-receiving unit 12 via the connector 909.

The light-receiving unit 12 is formed on a substrate 902, and includes a light-receiving element 910, a passive component 920, a frame component 930, an infrared cut filter 940, and a lens unit 950.

The light-receiving element 910 receives reflected light from an object at an effective pixel 911, forms an image as an image, and generates and outputs image data. The light-receiving element 910 is mounted on the substrate 902 on the back side of the light-receiving surface of the effective pixel 911. The light-receiving element 910 is electrically connected to the substrate 902 by wiring 912.

The passive component 920 is a circuit component excluding active elements such as a capacitor and a resistor.

The frame component 930 is a component to serve as a frame for mounting the lens unit 950. The frame component 930 is configured using an epoxy resin, a nylon resin, a liquid crystal polymer (LCP) resin, a polycarbonate resin, or the like. The frame component 930 is joined to the substrate 902 with an adhesive 939.

An infrared cut filter (IRCF) 940 is a filter that removes infrared light included in light incident from a lens 951 of the lens unit 950. The infrared cut filter 940 is formed at an opening of the frame component 930.

The lens unit 950 houses the lens 951. The lens unit 950 can adjust a focal position, a zoom, and the like of an image to be formed by moving the lens 951 in the vertical direction. Infrared light is removed from the light incident from the lens 951 of the lens unit 950 by the infrared cut filter 940, and the light is incident on the effective pixel 911 of the light-receiving element 910. The lens unit 950 is bonded to the frame component 930 with an adhesive 959.

The substrate 902 of the light-receiving unit 12 in the first example is formed as a rigid flexible printed wiring board. This rigid flexible printed wiring board is obtained by integrating a hard rigid board and a bendable flexible wiring board. Here, the light-receiving unit 12 is formed on the rigid board. Meanwhile, the flexible wiring board (flexible portion) of the rigid flexible printed wiring board is electrically connected to the connector 909 on the substrate 901 of the light-emitting unit 11, so that it is possible to form the distance measuring module 19 including the light-emitting unit 11 and the light-receiving unit 12.

Since the figure is a cross-sectional view, the lens unit 950 and the frame component 930 are illustrated as being present on the left and right, but the lens unit 950 and the frame component 930 are formed integrally. In addition, the passive component 920 does not necessarily need to be present on the rigid flexible printed wiring board.

Note that the structure of the light-receiving unit 12 is an example and is not limited to the structure described here.

FIG. 15 is a cross-sectional view illustrating a second example of the mounting structure of the distance measuring module 19 according to the embodiment of the present technology.

In the distance measuring module 19 according to the second example, the light-emitting unit 11 and the light-receiving unit 12 are mounted on the same motherboard or an interposer that performs relay to the motherboards. Hereinafter, the interposer or the motherboard is described as a substrate 903. Note that the substrate 903 is an example of the common substrate recited in the claims.

As described above, the light-emitting unit 11 reduces the wiring inductance by electrically connecting the semiconductor laser 300 and the laser driver 200 via the connecting via 101. In the second example, the light-emitting unit 11 is formed on a substrate 903.

The light-receiving unit 12 has a configuration similar to that of the first example. The light-receiving element 910 of the light-receiving unit 12 is mounted on the substrate 903 by, for example, chip on board (CoB). That is, the light-receiving element 910 is directly mounted as a bare chip on the substrate 903 by using an epoxy or silicone die attach material.

In the case of a chip scale package (CSP), for example, the light-receiving element 910 may be mounted on the substrate 903 by mass reflow (batch reflow). In this case, by mounting the light-receiving element 910 on the substrate 903 and then collectively performing reflow heating to melt a solder, the back surface of the light-receiving element 910 is bonded to the substrate 903 and mounted.

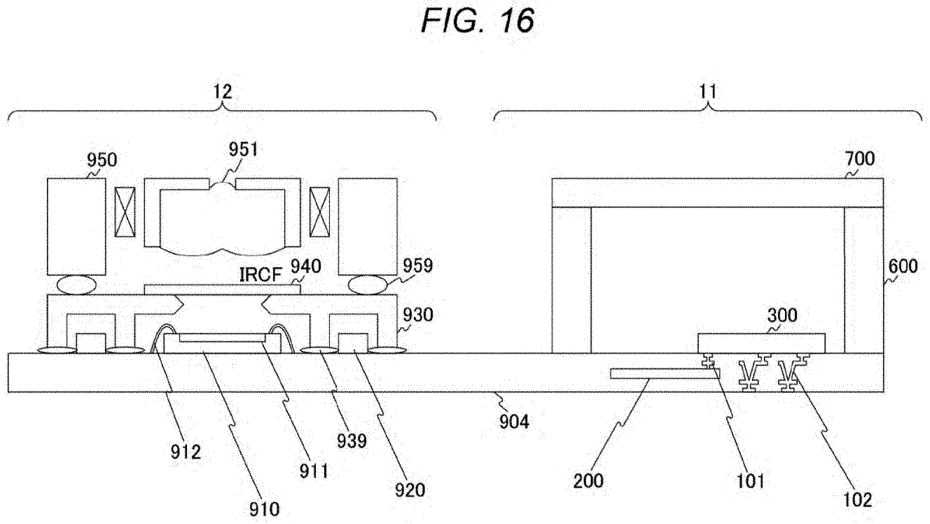

FIG. 16 is a cross-sectional view illustrating a third example of the mounting structure of the distance measuring module 19 according to the embodiment of the present technology.

The distance measuring module 19 according to the third example has a structure in which the light-receiving unit 12 is also mounted on a substrate 904 having the laser driver 200 of the light-emitting unit 11 built inside.

As described above, the light-emitting unit 11 reduces the wiring inductance by electrically connecting the semiconductor laser 300 and the laser driver 200 via the connecting via 101. In the third example, the laser driver 200 of the light-emitting unit 11 is built in the substrate 904.

The light-receiving unit 12 has a configuration similar to that of the first example. Further, similarly to the second example described above, the light-receiving element 910 of the light-receiving unit 12 may be mounted on the substrate 904 by CoB or may be mounted on the substrate 904 by mass reflow.

“Relationship Between Light-Emitting Unit and Light-Receiving Unit”

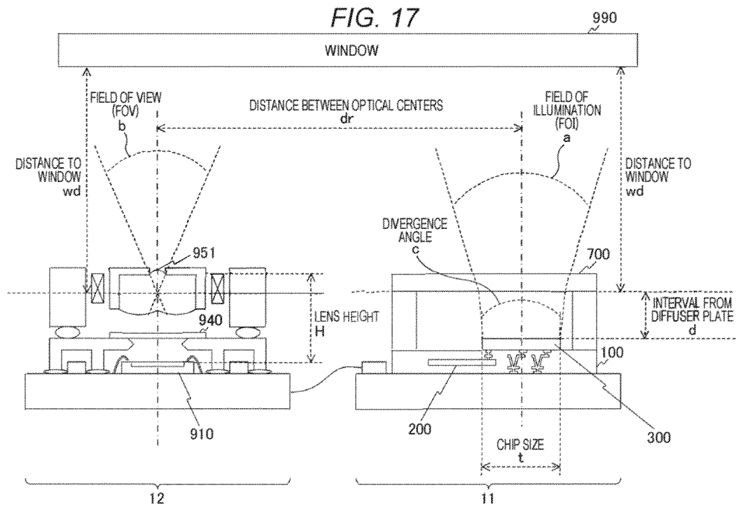

FIG. 17 is a cross-sectional view illustrating an example of an assumed size of the distance measuring module 19 according to the embodiment of the present technology. Note that this example is based on the first example described above.

On the subject side of the distance measuring module 19, a transparent glass or a resin window 990 is provided to protect the distance measuring module 19. The window 990 may be provided as a part of electronic equipment in which the distance measuring module 19 is stored. Here, for simplifying the structure of the electronic equipment to reduce its thickness, the window 990 is provided at the same height from the lower surfaces of the light-emitting unit 11 and the light-receiving unit 12. Note that the window 990 is an example of the transmission window recited in the claims.

In order to minimize (or reduce) the opening of the window 990, it is necessary to minimize (or reduce) the distance between the top of the lens of the light-receiving unit 12 and the window 990 and the distance between the diffuser plate 700 of the light-emitting unit 11 and the window 990. For minimizing (or reducing) the distance from both the light-emitting unit 11 and the light-receiving unit 12 to the window 990, the heights of the light-emitting unit 11 and the light-receiving unit 12 are desirably made equal.

Further, for preventing (or reducing) the occurrence of the inconsistency in the angle of view and the parallax between the light-emitting unit 11 and the light-receiving unit 12, the light-emitting unit 11 and the light-receiving unit 12 are desirably located at the same position (interval: zero). On the other hand, in a case where the angle of view of the illumination light (field of illumination (FOI)) of the light-emitting unit 11 and the angle of view of the lens (field of view (FOV)) of the light-receiving unit 12 overlap each other up to the position of the window 990, irradiation light (illumination light) emitted from the light-emitting unit 11 is reflected on the window 990 and enters the light-receiving unit 12.

Hence it is desirable that the angle of the illumination light of the light-emitting unit 11 and the light-receiving angle of view of the light-receiving unit 12 do not overlap each other up to the position of the window 990. Expressing this by a conditional expression, a distance dr between the optical centers of the light-emitting unit 11 and the light-receiving unit 12 is expressed by the following expression.

dr>t/2+wd×tan(a/2)+wd×tan(b/2)+d×tan(c/2)

Here, t is the chip size (one side) of the semiconductor laser 300, and wd is the distance between the light-emitting unit 11 and the window 990 and the distance between the light-receiving unit 12 and the window 990. Further, a is an angle of view FOI (diagonal) of the illumination light of the light-emitting unit 11, and b is a light-receiving angle of view FOV (diagonal) of the light-receiving unit 12. Further, c is a divergence angle (full width at half maximum (FWHM)) of the semiconductor laser 300, and d is an interval between the semiconductor laser 300 and the diffuser plate 700.

As a typical example, the distance dr is about 5 to 10 mm. Further, the size t is about 1.0 to 1.5 mm. Further, the distance wd is about 0.5 to 2.0 mm. Further, the angle of view a is about 70 to 80 degrees. Further, the angle of view b is about 70 to 80 degrees. Further, the angle c is about 13 to 25 degrees. Further, the interval d is about 0.5 to 1.5 mm.

As thus described, according to the embodiment of the present technology, in the light-emitting unit 11 of the distance measuring module 19, the wiring inductance can be reduced by electrically connecting the semiconductor laser 300 and the laser driver 200 via the connecting via 101. Specifically, by setting the wiring length between the semiconductor laser 300 and the laser driver 200 to 0.5 mm or less, the wiring inductance can be set to 0.5 nH or less. In addition, by setting the amount of overlap between the semiconductor laser 300 and the laser driver 200 to 50% or less, a certain number of thermal vias 102 can be arranged directly below the semiconductor laser 300, and favorable heat radiation characteristics can be obtained.

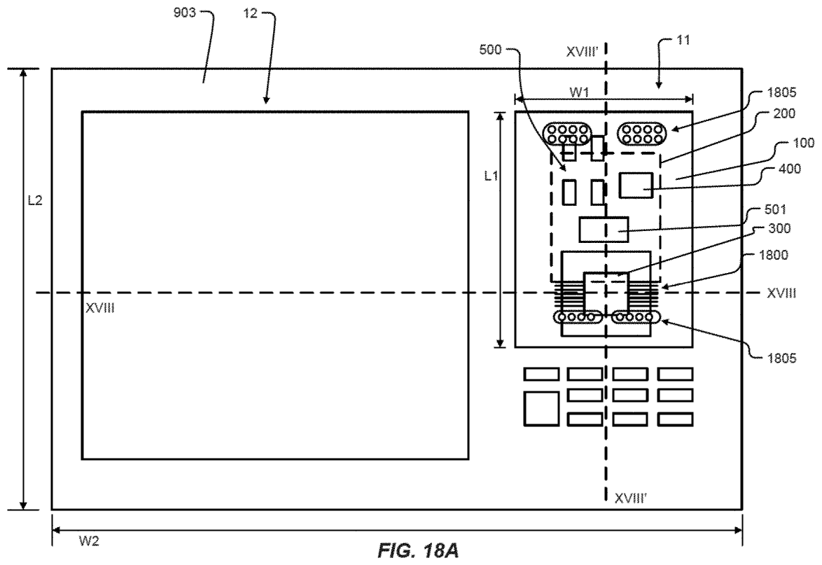

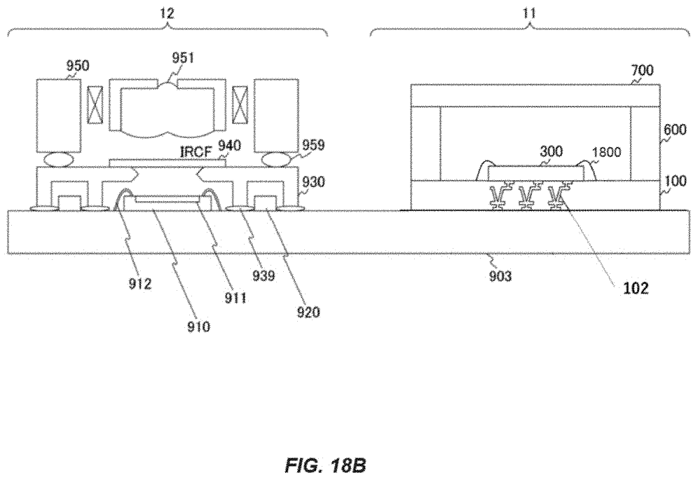

FIG. 18A is a view illustrating an example of a top view of a distance measuring module according to the embodiment of the present technology. FIG. 18B is a cross-sectional view illustrating an example of a mounting structure of the distance measuring module in FIG. 18A according to the embodiment of the present technology. As shown in FIG. 18A, a distance measuring module includes a light-emitting unit 11 and a light-receiving unit 12. As discussed with respect to certain previous figures, the light-emitting unit 11 includes a substrate 100, a laser driver 200, a semiconductor laser 300, a photodiode 400, passive components 500 and 501, wires 1800, and vias 1805. Four passive components 500 are shown, and each may include a capacitor. A passive component 501, for example, a capacitor is further shown, which may correspond to the unlabeled thin rectangle above the semiconductor laser 300 in FIG. 2. As shown, the laser driver 200 overlaps a portion (e.g., less than 50% of) the semiconductor laser 300. The laser driver 200 also completely overlaps the photodiode 400, the passive element 501, and two of the passive elements 500. As shown in the cross sectional view of FIG. 18B along line XVIII in FIG. 18A, the light-emitting unit 11 and light receiving unit 12 include the same elements as those described above with respect to certain previous figures (e.g., FIG. 16). Although not explicitly shown, the cross sectional view of the light-emitting unit 11 along line XVIII′ in FIG. 18A looks substantially the same as that depicted in FIG. 3 with the addition of passive element 501 mounted on the substrate 100. Here, it should be appreciated that the lines XVIII and XVIII′ may be considered to pass through centers of the semiconductor laser 300, the light-emitting unit 11, and/or the light-receiving unit 12. the semiconductor laser 300 is placed as shown in FIG. 18A to minimize (or reduce) a distance between the Light-receiving element 911 and the semiconductor laser 300. The distance module depicted in FIGS. 18A and 18B may have the same or similar measurements and/or relative sizes as shown and described with respect to FIG. 17.

### 2. Application Example

“Electronic Equipment”

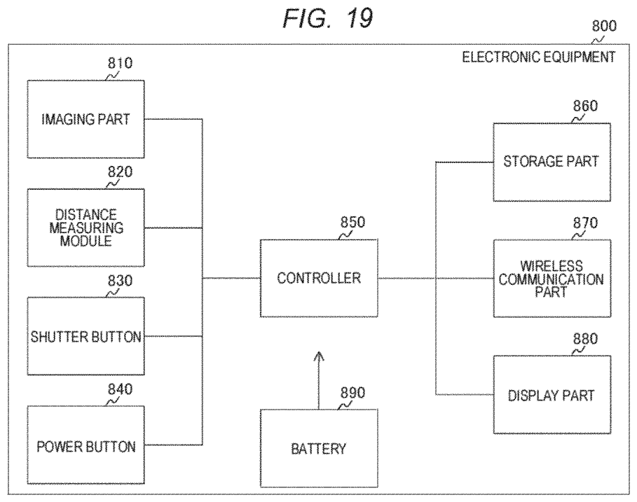

FIG. 19 is a diagram illustrating a system configuration example of electronic equipment 800 which is an application example of the embodiment of the present technology.

The electronic equipment 800 is a mobile terminal equipped with the distance measuring module according to the embodiment described above. The electronic equipment 800 includes an imaging part 810, a distance measuring module 820, a shutter button 830, a power button 840, a controller 850, a storage part 860, a wireless communication part 870, a display part 880, and a battery 890.

The imaging part 810 is an image sensor that captures an image of a subject. The distance measuring module 820 is the distance measuring module 19 according to the embodiment described above.

The shutter button 830 is a button for giving an instruction on the imaging timing in the imaging part 810 from the outside of the electronic equipment 800. The power button 840 is a button for giving an instruction on on/off of the power of the electronic equipment 800 from the outside of electronic equipment 800.

The controller 850 is a processing part that controls the entire electronic equipment 800. The storage part 860 is a memory that stores data and programs necessary for the operation of the electronic equipment 800. The wireless communication part 870 performs wireless communication with the outside of the electronic equipment 800. The display part 880 is a display that displays an image and the like. The battery 890 is a power supply source that supplies power to each part of electronic equipment 800.

With a specific phase (e.g., rising timing) of a light emission control signal for con-trolling the distance measuring module 820 taken as 0 degrees, the imaging part 810 detects the amount of light received from 0 degrees to 180 degrees as Q1 and detects the amount of light received from 180 degrees to 360 degrees as Q2. Further, the imaging part 810 detects the amount of light received from 90 degrees to 270 degrees as Q3 and detects the amount of light received from 270 degrees to 90 degrees as Q4. From these amounts Q1 to Q4 of light received, the controller 850 calculates a distance d to the object according to the following equation and displays the distance d on the display part 880.

d=(c/4πf)×arctan{(Q3−Q4)/(Q1−Q2)}

In the above equation, the unit of the distance d is, for example, meters (m). c is the speed of light, and its unit is, for example, meters per second (m/s). arctan is an inverse function of a tangent function. A value of “(Q3−Q4)/(Q1−Q2)” indicates the phase difference between irradiation light and reflected light. π indicates Pi. Further, f is the frequency of the irradiation light, and its unit is, for example, megahertz (MHz).

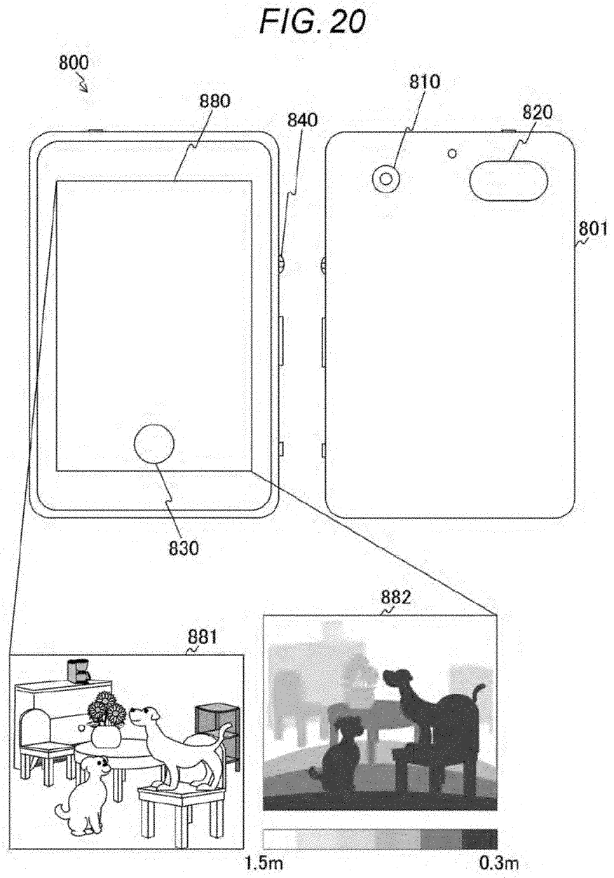

FIG. 20 is a view illustrating an external configuration example of the electronic equipment 800 which is an application example of the embodiment of the present technology.

The electronic equipment 800 is housed in a housing 801 and includes a power button 840 on a side surface and a display part 880 and a shutter button 830 on a surface. In addition, optical regions of the imaging part 810 and the distance measuring module are provided on the back surface.

As a result, the display part 880 can display not only the normal captured image 881 but also a depth image 882 corresponding to a result of distance measurement using ToF.

Note that although the mobile terminal such as a smartphone has been illustrated as the electronic equipment 800 in this application example, the electronic equipment 800 is not limited to this but may, for example, be a digital camera, a game machine, a wearable device, or the like.

Note that the embodiment described above shows an example for embodying the present technology, and the matters in the embodiment and the technology specifying matters in the claims have a corresponding relationship. Similarly, the technology specifying matters in the claims and the matters in the embodiment of the present technology to which the same names are assigned have a corresponding relationship. However, the present technology is not limited to the embodiment but can be embodied by applying various modifications to the embodiment without departing from the gist of the present technology.

Note that the effects described in the present specification are merely examples, are not limited, and may have other effects.

The present technology may be configured according to the following:

(1)

A device, comprising:
a first substrate;
a second substrate on the first substrate;
a light emitting device including:
   a light source on the second substrate and that emits light toward an object; and
   a driver disposed in the second substrate and that drives the light source, wherein a portion of the driver overlaps a first portion of the light source in a plan view; and
an imaging device on the first substrate adjacent to the light emitting device and that senses light reflected from the object.

(2)

The device of (1), wherein the light emitting device further comprises:
at least one first via disposed in the second substrate and overlapping with a second portion of the light source in the plan view.

(3)

The device of one or more of (1) to (2), wherein the at least one first via extends through the second substrate.

(4)

The device of one or more of (1) to (3), wherein the light emitting device further comprises:
at least one second via disposed in the second substrate that electrically connects the light source to the driver.

(5)

The device of one or more of (1) to (4), wherein the light emitting device further comprises at least one passive component on the second substrate.

(6)

The device of one or more of (1) to (5), further comprising:
a support structure that surrounds the at least one passive component and the light source.

(7)

The device of one or more of (1) to (6), further comprising an optical element supported by the support structure.

(8)

The device of one or more of (1) to (7), wherein the optical element diffuses light emitted from the light source.

(9)

The device of one or more of (1) to (8), wherein the support structure is mounted to the second substrate.

(10)

The device of one or more of (1) to (9), wherein the driver overlaps a portion of the at least one passive component in the plan view.

(11)

The device of one or more of (1) to (10), wherein the at least one passive component includes a decoupling capacitor.

(12)

The device of one or more of (1) to (11), wherein the first portion of the light source is less than 50% of a surface area of a surface of the light source.

(13)

The device of one or more of (1) to (12), wherein the light source includes a laser.

(14)

The device of one or more of (1) to (13), wherein a footprint of the imaging device is greater than a footprint of the light emitting device.

(15)

A device, comprising:
a light emitting device including:
   a light source on a first substrate and that emits light toward an object; and
   a driver disposed in the first substrate and that drives the light source, wherein a portion of the driver overlaps less than 50% of the light source in a plan view; and
an imaging device that senses light reflected from the object.

(16)

The device of (15), further comprising:
a second substrate, wherein the imaging device and the first substrate are mounted on the second substrate.

(17)

The device of one or more of (15) to (16), wherein the light emitting device further comprises:
at least one first via disposed in the second substrate and overlapping the light source in the plan view.

(18)

The device of one or more of (15) to (17), wherein the at least one first via extends through the first substrate.

(19)

The device of one or more of (15) to (18), wherein the light emitting device further comprises:
at least one second via disposed in the second substrate that electrically connects the light source to the driver.

(20)

A device, comprising:
a first substrate;
a light emitting device including:
   a light source on the first substrate and that emits light toward an object; and
   a driver disposed in the second substrate and that drives the light source, wherein a portion of the driver overlaps a first portion of the light source in a plan view;
a second substrate; and
an imaging device on the second substrate and that senses light reflected from the object; and
a connector that electrically connects the light emitting device to the imaging device.

Note that the present technology can also have configurations as follows.

(1) A distance measuring device including:

a substrate with a laser driver built inside;

a semiconductor laser that is mounted on one surface of the substrate and emits irradiation light;

connection wiring that electrically connects the laser driver and the semiconductor laser with a wiring inductance of 0.5 nH or less; and

a light-receiving unit that receives reflected light from an object to the irradiation light.

(2) The distance measuring device according to (1) above, further including

a distance measuring operation part that measures a distance to the object on the basis of the irradiation light and the reflected light.

(3) The distance measuring device according to (1) or (2) above, in which

the light-receiving unit is formed on a rigid board in a rigid flexible printed wiring board in which the rigid board and a flexible wiring board are integrated, and the light-receiving unit is connected to the substrate with the laser driver built inside via the flexible wiring board.

(4) The distance measuring device according to (1) or (2) above, in which

the substrate with the laser driver built inside and the light-receiving unit are formed on a same common substrate.

(5) The distance measuring device according to (4) above, in which

the common substrate is a motherboard or an interposer that performs relay to the motherboard.

(6) The distance measuring device according to (1) or (2) above, in which

the light-receiving unit is formed on the substrate with the laser driver built inside.

(7) The distance measuring device according to any one of (1) to (6) above, further including

a transmission window that transmits the irradiation light and the reflected light, in which

an angle of the irradiation light from a light-emitting unit and a light-receiving angle of view of the light-receiving unit do not overlap each other up to a position of the transmission window.

(8) The distance measuring device according to any one of (1) to (7) above, in which the connection wiring has a length of 0.5 mm or less.

(9) The distance measuring device according to any one of (1) to (8) above, in which the connection wiring is through a connecting via provided on the substrate.

(10) The distance measuring device according to any one of (1) to (9) above, in which a part of the semiconductor laser is disposed to overlap above the laser driver.

(11) The distance measuring device according to (10) above, in which a portion of 50% or less of an area of the semiconductor laser is disposed to overlap above the laser driver.

(12) Electronic equipment including:

a substrate with a laser driver built inside;

a semiconductor laser that is mounted on one surface of the substrate and emits irradiation light;

connection wiring that electrically connects the laser driver and the semiconductor laser with a wiring inductance of 0.5 nH or less; and

a light-receiving unit that receives reflected light from an object to the irradiation light.

(13) A method for manufacturing a distance measuring device, including:

forming a laser driver on an upper surface of a support plate;

forming connection wiring of the laser driver and forming a substrate with the laser driver built inside;

mounting a semiconductor laser that emits irradiation light on one surface of the substrate and forming connection wiring that electrically connects, via the connection wiring, the laser driver and the semiconductor laser with a wiring inductance of 0.5 nH or less; and

forming a light-receiving unit that receives reflected light from an object, the light corresponding to the irradiation light.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

11 Light-emitting unit
12 Light-receiving unit
13 Light emission controller
14 Distance measuring operation part
19 Distance measuring module
100 Substrate
101 connecting via
110 Support plate
120 Adhesive resin layer
130 Peelable copper foil
131 Carrier copper foil
132 Ultra-thin copper foil
140 Solder resist
150 Wiring pattern
161 to 163 Interlayer insulating resin
170 to 172 Via hole
180 Solder resist
200 Laser driver
210 I/O pad
220 Protective insulation layer
230 Surface protection film
240 Adhesion layer-seed layer
250 Photoresist
260 Copper land-copper wiring layer (RDL)
290 Die attach film (DAF)
300 Semiconductor laser
400 Photodiode
500 Passive component
600 Side wall
700 Diffuser plate
800 Electronic equipment
801 Housing
810 Imaging part
820 Distance measuring module
830 Shutter button
840 Power button
850 Controller
860 Storage part
870 Wireless communication part
880 Display part
890 Battery
901 to 904 Substrate
909 Connector
910 Light-receiving element
920 Passive component
930 Frame component
939, 959 Adhesive
940 Infrared cut filter
950 Lens unit
951 Lens
990 Window

What is claimed is:

1. A device, comprising:
a first substrate;
a second substrate on the first substrate;
a light emitting device including:
a light source on the second substrate and that emits light toward an object; and
a driver disposed in the second substrate and that drives the light source, wherein a portion of the driver overlaps a first portion of the light source in a plan view; and
an imaging device on the first substrate adjacent to the light emitting device and that senses light reflected from the object.

2. The device of claim 1, wherein the light emitting device further comprises:
at least one first via disposed in the second substrate and overlapping with a second portion of the light source in the plan view.

3. The device of claim 2, wherein the at least one first via extends through the second substrate.

4. The device of claim 2, wherein the light emitting device further comprises:
at least one second via disposed in the second substrate that electrically connects the light source to the driver.

5. The device of claim 1, wherein the light emitting device further comprises at least one passive component on the second substrate.

6. The device of claim 5, further comprising:
a support structure that surrounds the at least one passive component and the light source.

7. The device of claim 6, further comprising an optical element supported by the support structure.

8. The device of claim 7, wherein the optical element diffuses light emitted from the light source.

9. The device of claim 5, wherein the support structure is mounted to the second substrate.

10. The device of claim 5, wherein the driver overlaps a portion of the at least one passive component in the plan view.

11. The device of claim 5, wherein the at least one passive component includes a decoupling capacitor.

12. The device of claim 1, wherein the first portion of the light source is less than 50% of a surface area of a surface of the light source.

13. The device of claim 1, wherein the light source includes a laser.

14. The device of claim 1, wherein a footprint of the imaging device is greater than a footprint of the light emitting device.

15. A device, comprising:
a light emitting device including:
a light source on a first substrate and that emits light toward an object; and
a driver disposed in the first substrate and that drives the light source, wherein a portion of the driver overlaps less than 50% of the light source in a plan view; and
an imaging device that senses light reflected from the object.

16. The device of claim 15, further comprising:
a second substrate, wherein the imaging device and the first substrate are mounted on the second substrate.

17. The device of claim 15, wherein the light emitting device further comprises:
at least one first via disposed in the second substrate and overlapping the light source in the plan view.

18. The device of claim 17, wherein the at least one first via extends through the first substrate.

19. The device of claim 17, wherein the light emitting device further comprises:
at least one second via disposed in the second substrate that electrically connects the light source to the driver.

20. A device, comprising:
a first substrate;
a light emitting device including:
a light source on the first substrate and that emits light toward an object; and
a driver disposed in the second substrate and that drives the light source, wherein a portion of the driver overlaps a first portion of the light source in a plan view;
a second substrate;
an imaging device on the second substrate and that senses light reflected from the object; and
a connector that electrically connects the light emitting device to the imaging device.
